(19) United States
(12) Patent Application Publication
(10) Pub. No.: US 2013/0313486 A1
(43) Pub. Date: Nov. 28, 2013

(54) ELECTRODE FOR NON-AQUEOUS ELECTROLYTE SECONDARY BATTERY, METHOD FOR PRODUCING SAME, AND NON-AQUEOUS ELECTROLYTE SECONDARY BATTERY

(71) Applicants: Masanori Sugimori, Kobe City (JP); Kazunari Okita, Moriguchi City (JP); Yoshinori Kida, Kobe City (JP)

(72) Inventors: Masanori Sugimori, Kobe City (JP); Kazunari Okita, Moriguchi City (JP); Yoshinori Kida, Kobe City (JP)

(73) Assignee: SANYO ELECTRIC CO., LTD., Moriguchi-shi, Osaka (JP)

(21) Appl. No.: 13/984,144

(22) PCT Filed: Nov. 18, 2011
(86) PCT No.: PCT/JP2011/076640

§ 371 Date: Aug. 7, 2013

(30) Foreign Application Priority Data
Feb. 23, 2011 (JP) 2011-036911

(51) Int. Cl. H01M 4/62; H01M 4/131; H01M 4/485

(52) U.S. Cl. CPC H01M 4/625; H01M 4/485; H01M 4/131; H01M 4/623
USPC 252/506; 429/217

(57) ABSTRACT

Provided are an electrode for a non-aqueous electrolyte secondary battery capable of improving the dispersibility of a conducting agent in the electrode and forming a good conductive network, a method for producing the same, and a non-aqueous electrolyte secondary battery. An electrode for a non-aqueous electrolyte secondary battery includes an active material, a binder, carbon nanotubes, and a non-fibrous conductive carbon material, characterized in that the electrode includes a polyvinylpyrrolidone-based polymer in an amount in the range of 5 to 25 parts by mass relative to 100 parts by mass of the carbon nanotubes.

### TECHNICAL FIELD

The present invention relates to an electrode for a non-aqueous electrolyte secondary battery containing carbon nanotubes, a method for producing the same, and a non-aqueous electrolyte secondary battery.

### BACKGROUND ART

In recent years, there has been a marked progress in the reduction of the size and weight of mobile devices, such as mobile phones, notebook computers, and PDAs, and with an increase in functionality, power consumption has been increased. In non-aqueous electrolyte secondary batteries used as power sources for these mobile devices, there has also been an increased demand for a reduction in weight and an increase in capacity.

Furthermore, as power sources for hybrid electric cars, nickel-metal hydride rechargeable batteries have been generally widely used. The use of non-aqueous electrolyte secondary batteries as power sources having a higher capacity and high output has been studied.

When an electrode for such a non-aqueous electrolyte secondary battery is fabricated, a slurry is prepared by adding an active material, a conducting agent, and a binder into a solvent, and the slurry is applied to a current collector, followed by drying. In such an electrode, when the dispersibility of the conducting agent is decreased, it is not possible to sufficiently bring out the performance of the active material, which is a problem.

For the purpose of improving the dispersibility of the conducting agent, Patent Literature 1 discloses a method in which a polyvinylpyrrolidone-based polymer is used as a dispersant.

However, in the method described in Patent Literature 1, when the addition amount of the dispersant is increased in order to obtain a slurry having good dispersion stability, electric conductivity is impaired, and battery characteristics are degraded, which is a problem.

On the other hand, regarding the conducting agent, a fibrous carbon material is likely to form electrically conducting paths inside the electrode because of its peculiar shape, and it is known that use of a small amount of the fibrous carbon material can reduce the internal resistance of the electrode. As such a fibrous carbon material, carbon nanotubes, VGCF (registered trademark), and the like have been under study.

However, in the fibrous carbon material, from the standpoint of slurry stability and battery characteristics, improvement in dispersibility is also a problem. As the diameter of the fibrous carbon material decreases, van der Waals forces increase. As a result, cohesive forces also increase. Therefore, it becomes difficult to disperse, for example, carbon nanotubes with a diameter of 50 nm or less only by relying on the capability of a dispersing device. Consequently, detachment of the electrode mixture layer from the current collector is likely to occur, which is a problem.

Patent Literature 2 discloses a method in which, for the purpose of dispersing carbon nanotubes, the surface thereof is modified by a polyvinylpyrrolidone-based polymer.

However, in the case where an electrode is fabricated by the method described in Patent Literature 2, since carbon nanotubes are disposed on the surface of the active material, electric conductivity between secondary particles of the active material is insufficient, and improvement in battery characteristics is insufficient.

Patent Literature 3 discloses a method in which uniformity is improved by mixing fibrous carbon and non-fibrous carbon.

However, in the method described in Patent Literature 3, aggregation of fibrous carbon remains, and detachment of the electrode mixture layer from the current collector is likely to occur, which is a problem.

### CITATION LIST

### Patent Literature

PTL 1: Japanese Published Unexamined Patent Application No. 2003-157846

PTL 2: Japanese Published Unexamined Patent Application No. 2010-67436

PTL 3: Japanese Published Unexamined Patent Application No. 2010-238575

### SUMMARY OF INVENTION

### Technical Problem

It is an object of the present invention to provide an electrode for a non-aqueous electrolyte secondary battery capable of improving the dispersibility of a conducting agent in the electrode and forming a good conductive network, a method for producing the same, and a non-aqueous electrolyte secondary battery in which output characteristics are improved by using the electrode.

### Solution to Problem

An electrode for a non-aqueous electrolyte secondary battery according to the present invention includes an active material, a binder, carbon nanotubes, and a non-fibrous conductive carbon material, characterized in that the electrode includes a polyvinylpyrrolidone-based polymer in an amount in the range of 5 to 25 parts by mass relative to 100 parts by mass of the carbon nanotubes.

In the present invention, the electrode includes, as conducting agents, carbon nanotubes and a non-fibrous conductive carbon material. In the present invention, by further incorporating a polyvinylpyrrolidone-based polymer, the surface of the carbon nanotubes can be modified, and aggregation thereof can be broken. Thereby, the carbon nanotubes can be disposed on the surface of the active material. Furthermore, thereby, the non-fibrous conductive carbon material incorporated together with the carbon nanotubes can be disposed between active material particles, and electric conductivity between the active material particles can be complemented. Consequently, in accordance with the present invention, the current-collecting property originating from the active material can be enhanced and a good conductive network can be formed in the electrode.

Furthermore, by using the electrode of the present invention, it is possible to obtain a non-aqueous electrolyte secondary battery having excellent output characteristics.

In the present invention, the electrode includes a polyvinylpyrrolidone-based polymer in an amount in the range of 5 to 25 parts by mass relative to 100 parts by mass of the carbon nanotubes. By incorporating the polyvinylpyrrolidone-based polymer in such a range of amount, a good conductive network can be formed in the electrode, and it is possible to obtain a non-aqueous electrolyte secondary battery having excellent output characteristics.

Examples of the polyvinylpyrrolidone-based polymer used in the present invention include polymers of vinylpyrrolidone and copolymers of vinylpyrrolidone and another vinyl compound.

In the present invention, the diameter of the carbon nanotubes is preferably 50 nm or less. By setting the diameter of the carbon nanotubes at 50 nm or less, it is possible to enhance contact with the surface of the active material, and to collect current efficiently. The lower limit of the diameter of the carbon nanotubes is not particularly limited, but is generally 0.4 nm or more. The carbon nanotubes may have a single-wall structure or a multi-wall structure. Preferably, the carbon nanotubes have a multi-wall structure.

In the present invention, examples of the non-fibrous conductive carbon material include carbon black, such as furnace black, acetylene black, or Ketjenblack, and graphite. As the non-fibrous conductive carbon material, carbon black is particularly preferably used.

In the present invention, the ratio of the carbon nanotubes to the non-fibrous conductive carbon material (carbon nanotubes: non-fibrous conductive carbon material), in terms of mass ratio, is preferably in the range of 1:9 to 9:1, and more preferably in the range of 1:9 to 3:2. By using them in such a ratio range, a better conductive network can be formed.

In the present invention, the active material is not particularly limited as long as it can be used for an electrode for a non-aqueous electrolyte secondary battery. For example, a known positive electrode active material or negative electrode active material can be used. The present invention can be particularly suitably applied to an active material having poor electric conductivity because a good conductive network can be formed in the electrode.

Examples of the positive electrode active material include lithium transition metal composite oxides containing, as a transition metal, cobalt, nickel, manganese, or the like. Among them, lithium transition metal composite oxides containing nickel and manganese as transition metals generally have poor electric conductivity, and thus are positive electrode active materials that particularly require the advantages of the present invention. Examples of the lithium transition metal composite oxides containing nickel and manganese include a lithium-nickel composite oxide, a lithium-nickel-cobalt composite oxide, a lithium-nickel-cobalt-aluminum composite oxide, a lithium-nickel-cobalt-manganese composite oxide.

Examples of the negative electrode active material include carbon materials, such as graphite, and a material, such as silicon or tin, that forms an alloy with lithium.

The binder used in the present invention is not particularly limited, and a material that has been used as a binder for an electrode for a non-aqueous electrolyte secondary battery can be used. Examples thereof include polyvinylidene fluoride and polyimide.

A production method of the present invention is a method that can produce the electrode for a non-aqueous electrolyte secondary battery according to the present invention described above, and is characterized by including a step of preparing a slurry including an active material, a binder, carbon nanotubes, a non-fibrous conductive carbon material, a polyvinylpyrrolidone-based polymer, and a solvent, and a step of applying the slurry onto a current collector, followed by drying.

In the present invention, first, a slurry including an active material, a binder, carbon nanotubes, a non-fibrous conductive carbon material, a polyvinylpyrrolidone-based polymer, and a solvent is prepared. By incorporating the polyvinylpyrrolidone-based polymer, the dispersibility of the carbon nanotubes and the non-fibrous conductive carbon material can be improved, properties of the slurry can be kept in a good condition, and coating properties to the current collector can be improved.

The solvent of the slurry is not particularly limited as long as it can dissolve the binder. As an organic solvent, N-methyl-2-pyrrolidone is particularly preferably used. In the case where an aqueous slurry is prepared, an aqueous solvent can be used.

While the order of addition is not particularly limited in the preparation of the slurry, it is preferable to mix the carbon nanotubes, the non-fibrous conductive carbon material, and the polyvinylpyrrolidone-based polymer in advance before the active material is added.

The electrode in the present invention may be a positive electrode or a negative electrode. Consequently, in the case where a positive electrode is produced, a slurry including a positive electrode active material is applied onto a positive electrode current collector, followed by drying to produce the positive electrode. Furthermore, in the case where a negative electrode is produced, by applying a slurry including a negative electrode active material onto a negative electrode current collector, followed by drying, the negative electrode can be produced. As the positive electrode current collector, an aluminum foil or the like can be generally used. As the negative electrode current collector, a copper foil or the like can be generally used.

According to the production method of the present invention, an electrode for a non-aqueous electrolyte secondary battery, in which the dispersibility of the conducting agent in the electrode is improved and which can form a good conductive network, can be produced efficiently.

A non-aqueous electrolyte secondary battery of the present invention is characterized in that the electrode of the present invention described above is used as a positive electrode or a negative electrode.

The non-aqueous electrolyte secondary battery of the present invention includes a positive electrode, a negative electrode, and a non-aqueous electrolyte. The non-aqueous solvent used for the non-aqueous electrolyte is not particularly limited. Specific examples of the non-aqueous solvent which is preferably used include cyclic carbonates, such as ethylene carbonate, propylene carbonate, butylene carbonate, and vinylene carbonate, linear carbonates, such as dimethyl carbonate, methyl ethyl carbonate, and diethyl carbonate, and mixed solvents of a cyclic carbonate and a linear carbonate.

Examples of the solute used in the non-aqueous electrolyte include LiPF₆, LiBF₄, LiCF₃SO₃, LiN(CF₃SO₂)₂, LiN (C₂F₅SO₂)₂, LiN (CF₃SO₂) (C₄F₉SO₂), LiC (C₂F₅SO₂)₃, LiAsF₆, and LiCl₄.

### Advantageous Effects of Invention

According to the present invention, it is possible to provide an electrode for a non-aqueous electrolyte secondary battery in which the dispersibility of the conducting agent in the electrode is improved and a good conductive network can be formed.

According to the production method of the present invention, it is possible to efficiently produce an electrode for a non-aqueous electrolyte secondary battery in which the dispersibility of the conducting agent in the electrode is improved and a good conductive network can be formed.

In the non-aqueous electrolyte secondary battery of the present invention, since the electrode for a non-aqueous electrolyte secondary battery according to the present invention described above is used, output characteristics can be improved.

### BRIEF DESCRIPTION OF DRAWINGS

FIG. 1 is a graph showing output characteristics in examples according to the present invention and comparative examples.

FIG. 2 is a graph showing output characteristics in examples according to the present invention and comparative examples.

FIG. 3 is a schematic view showing a three-electrode test cell.

### DESCRIPTION OF EMBODIMENTS

Specific examples according to the present invention will be described below. However, it is to be understood that the present invention is not limited to the examples below.

### EXAMPLE 1

[Production of Conducting Agent Paste]

A polyvinylpyrrolidone-based polymer (trade name “PITZCOL K-30”, manufactured by Dai-ichi Kogyo Seiyaku Co., Ltd.) was dissolved in N-methyl-2-pyrrolidone (NMP). Then, carbon nanotubes and acetylene black serving as a non-fibrous conductive carbon material were added, at a mass ratio (carbon nanotubes:acetylene black) of 3:2, into the solution, and mixing was performed. The diameter (fiber diameter) of the carbon nanotubes used was about 15 nm. Furthermore, the polyvinylpyrrolidone-based polymer was added in an amount of 5 parts by mass relative to 100 parts by mass of the carbon nanotubes. Consequently, the content ratio of carbon nanotubes:acetylene black:polyvinylpyrrolidone-based polymer, in terms of mass ratio, was 3:2:0.15.

In such a manner, a conducting agent paste was prepared.

[Preparation of Positive Electrode Mixture Slurry]

Using polyvinylidene fluoride as a binder, a solution was prepared by dissolving polyvinylidene fluoride in NMP. The resulting solution, the conducting agent paste, and a positive electrode active material were mixed at a mass ratio, positive electrode active material:conducting agent (carbon nanotubes and acetylene black): binder, of 92:5:3 to produce a positive electrode mixture slurry. Consequently, in the positive electrode mixture slurry, the mass ratio of positive electrode active material:carbon nanotubes:acetylene black:polyvinylpyrrolidone-based polymer:binder was 92:3:2:0.15:3.

As the positive electrode active material, Li_{1.1}Ni_{0.5}Co_{0.2}Mn_{0.3}O₂ was used.

[Production of Positive Electrode]

The positive electrode mixture slurry was applied onto a positive electrode current collector composed of an aluminum foil, followed by drying, and then rolling was performed with a roller. A current collecting tab composed of aluminum was attached to the resulting workpiece to produce a positive electrode.

[Production of Three-electrode Test Cell]

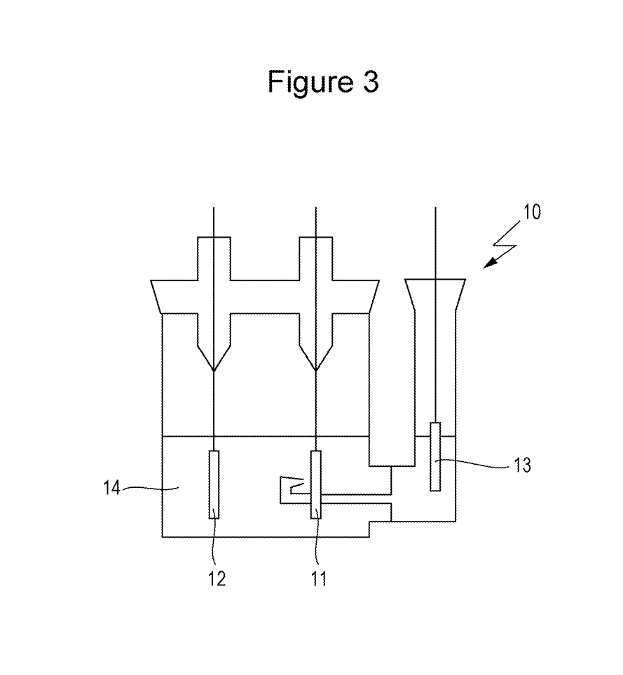

Using the resulting positive electrode as a working electrode, a three-electrode test cell 10 shown in FIG. 3 was produced.

As shown in FIG. 3, a working electrode 11, a counter electrode 12, and a reference electrode 13 were immersed in a non-aqueous electrolytic solution 14. The counter electrode 12 and the reference electrode 13 were each composed of metallic lithium. Furthermore, as the non-aqueous electrolytic solution 14, a solution was prepared by dissolving LiPF₆, with a concentration of 1 mol/liter, in a mixed solvent in which ethylene carbonate, methyl ethyl carbonate, and dimethyl carbonate were mixed at a volume ratio of 3:3:4, and further dissolving 1% by weight of vinylene carbonate therein.

### EXAMPLE 2

A three-electrode test cell was produced as in Example 1 except that a conducting agent paste was prepared such that the amount of the polyvinylpyrrolidone-based polymer was 10 parts by mass relative to 100 parts by mass of the carbon nanotubes.

### EXAMPLE 3

A three-electrode test cell was produced as in Example 1 except that a conducting agent paste was prepared such that the amount of the polyvinylpyrrolidone-based polymer was 20 parts by mass relative to 100 parts by mass of the carbon nanotubes.

### EXAMPLE 4

A three-electrode test cell was produced as in Example 1 except that a conducting agent paste was prepared such that carbon nanotubes and acetylene black were mixed at a mass ratio (carbon nanotubes:acetylene black) of 1:9, and the amount of the polyvinyl polyvinylpyrrolidone-based polymer was 20 parts by mass relative to 100 parts by mass of the carbon nanotubes.

### EXAMPLE 5

A three-electrode test cell was produced as in Example 1 except that a conducting agent paste was prepared such that carbon nanotubes and acetylene black were mixed at a mass ratio (carbon nanotubes:acetylene black) of 1:4, and the amount of the polyvinyl polyvinylpyrrolidone-based polymer was 20 parts by mass relative to 100 parts by mass of the carbon nanotubes.

### EXAMPLE 6

A three-electrode test cell was produced as in Example 1 except that a conducting agent paste was prepared such that carbon nanotubes and acetylene black were mixed at a mass ratio (carbon nanotubes:acetylene black) of 3:7, and the amount of the polyvinyl polyvinylpyrrolidone-based polymer was 20 parts by mass relative to 100 parts by mass of the carbon nanotubes.

### EXAMPLE 7

A three-electrode test cell was produced as in Example 1 except that a conducting agent paste was prepared such that carbon nanotubes and acetylene black were mixed at a mass ratio (carbon nanotubes:acetylene black) of 2:3, and the amount of the polyvinyl polyvinylpyrrolidone-based polymer was 20 parts by mass relative to 100 parts by mass of the carbon nanotubes.

### EXAMPLE 8

A three-electrode test cell was produced as in Example 1 except that a conducting agent paste was prepared such that carbon nanotubes and acetylene black were mixed at a mass ratio (carbon nanotubes:acetylene black) of 5:5, and the amount of the polyvinyl polyvinylpyrrolidone-based polymer was 20 parts by mass relative to 100 parts by mass of the carbon nanotubes.

### EXAMPLE 9

A three-electrode test cell was produced as in Example 1 except that a conducting agent paste was prepared such that carbon nanotubes and acetylene black were mixed at a mass ratio (carbon nanotubes:acetylene black) of 7:3, and the amount of the polyvinyl polyvinylpyrrolidone-based polymer was 20 parts by mass relative to 100 parts by mass of the carbon nanotubes.

### EXAMPLE 10

A three-electrode test cell was produced as in Example 1 except that a conducting agent paste was prepared such that carbon nanotubes and acetylene black were mixed at a mass ratio (carbon nanotubes:acetylene black) of 4:1, and the amount of the polyvinyl polyvinylpyrrolidone-based polymer was 20 parts by mass relative to 100 parts by mass of the carbon nanotubes.

### EXAMPLE 11

A three-electrode test cell was produced as in Example 1 except that a conducting agent paste was prepared such that carbon nanotubes and acetylene black were mixed at a mass ratio (carbon nanotubes:acetylene black) of 9:1, and the amount of the polyvinyl polyvinylpyrrolidone-based polymer was 20 parts by mass relative to 100 parts by mass of the carbon nanotubes.

### COMPARATIVE EXAMPLE 1

A three-electrode test cell was produced as in Example 1 except that acetylene black only was used as a conducting agent, and the polyvinylpyrrolidone-based polymer was not added.

### COMPARATIVE EXAMPLE 2

A three-electrode test cell was produced as in Example 1 except that the polyvinylpyrrolidone-based polymer was not added.

### COMPARATIVE EXAMPLE 3

A three-electrode test cell was produced as in Example 1 except that a conducting agent paste was prepared such that the amount of the polyvinylpyrrolidone-based polymer was 30 parts by mass relative to 100 parts by mass of the carbon nanotubes.

### COMPARATIVE EXAMPLE 4

A three-electrode test cell was produced as in Example 1 except that a conducting agent paste was prepared such that the amount of the polyvinylpyrrolidone-based polymer was 40 parts by mass relative to 100 parts by mass of the carbon nanotubes.

### COMPARATIVE EXAMPLE 5

A three-electrode test cell was produced as in Example 1 except that a conducting agent paste was prepared such that the amount of the polyvinylpyrrolidone-based polymer was 50 parts by mass relative to 100 parts by mass of the carbon nanotubes.

### COMPARATIVE EXAMPLE 6

A three-electrode test cell was produced as in Example 1 except that a conducting agent paste was prepared such that carbon nanotubes only were used as a conducting agent, and the amount of the polyvinylpyrrolidone-based polymer was 20 parts by mass relative to 100 parts by mass of the carbon nanotubes.

[Evaluation of Output Characteristics]

Regarding each of the three-electrode test cells of examples and comparative examples produced as described above, output characteristics were evaluated as described below.

At 25° C., the three-electrode test cell was charged at a constant current density of 0.2 mA/cm² until 4.3 V (vs. Li/Li⁺), and then charged at a constant voltage of 4.3 V (vs. Li/Li⁺) until the current density reached 0.04 mA/cm². Subsequently, the three-electrode test cell was discharged at a constant current density of 0.2 mA/cm² until 2.5 V (vs. Li/Li⁺).

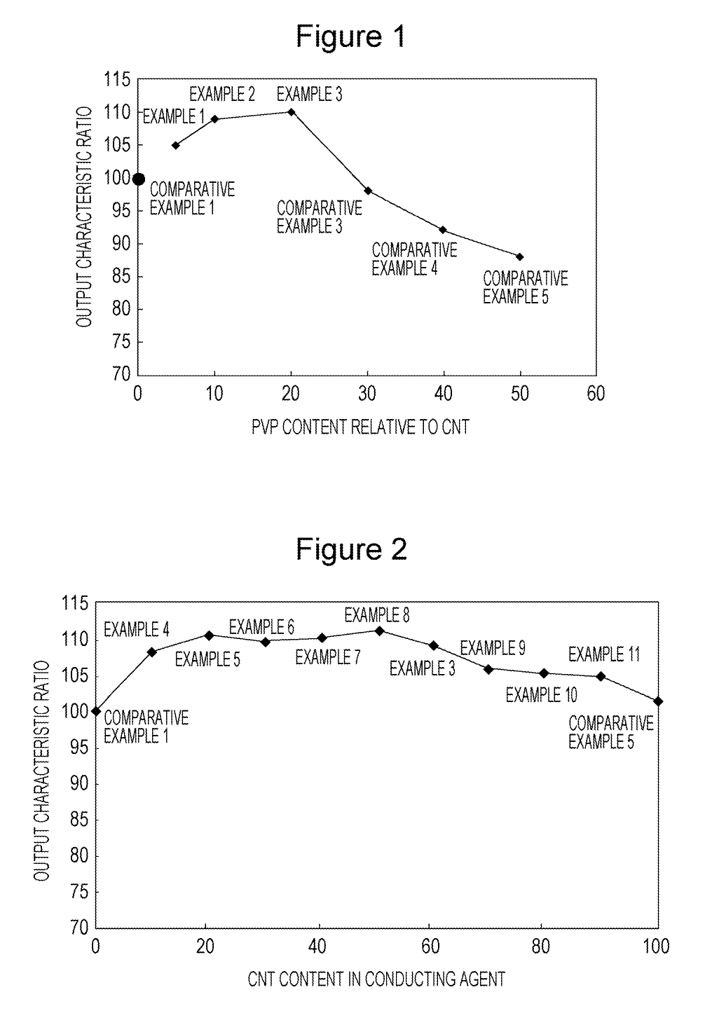

Next, at the point in which each of the three-electrode test cells was charged up to 50% of the rated capacity (i.e., at a state of charge (SOC) of 50%), the output was measured when discharged at 25° C. Discharging was performed for 10 seconds at a current density of 0.08 mA/cm², 0.4 mA/cm², 0.8 mA/cm², and 1.6 mA/cm². In each case, the battery voltage 10 seconds after the discharge was plotted against the current to determine the current at a battery voltage of 2.5 V by extrapolation, and thus the output was calculated. Tables 1 to 3 and FIGS. 1 and 2 show the measurement results of the output characteristics of the individual cells as output characteristic ratios. The output characteristic ratios shown in Tables 1 to 3 and FIGS. 1 and 2 are relative values when the output of the three-electrode test cell of Comparative Example 1 is defined as 100%.

TABLE 1

| | PVP content | Output characteristic |
|---|---|---|
| | relative to CNT | ratio (25° C.) (%) |
| Comparative Example 1 | — | 100 |
| Comparative Example 2 | 0 | Unable to fabricate |
| Example 1 | 5 | 105 |
| Example 2 | 10 | 109 |
| Example 3 | 20 | 110 |
| Comparative Example 3 | 30 | 98 |
| Comparative Example 4 | 40 | 92 |
| Comparative Example 5 | 50 | 88 |

TABLE 2

| | CNT | Acetylene | PVP content | Output |
|---|---|---|---|---|
| | ratio in | black ratio | relative | character- |
| | conducting | in conducting | to CNT | istic ratio |
| | agent (mass %) | agent (mass %) | (mass %) | (25° C.) |
| Comparative | 0 | 100 | — | 100 |
| Example 1 | | | | |
| Comparative | 60 | 40 | 0 | Unable to |
| Example 2 | | | | fabricate |
| Example 1 | 60 | 40 | 5 | 105 |
| Example 2 | 60 | 40 | 10 | 109 |
| Example 3 | 60 | 40 | 20 | 110 |
| Comparative | 60 | 40 | 30 | 98 |
| Example 3 | | | | |
| Comparative | 60 | 40 | 40 | 92 |
| Example 4 | | | | |
| Comparative | 60 | 40 | 50 | 88 |
| Example 5 | | | | |

TABLE 3

| | CNT | Acetylene | PVP content | Output |
|---|---|---|---|---|
| | ratio in | black ratio | relative | character- |
| | conducting | in conducting | to CNT | istic ratio |
| | agent (mass %) | agent (mass %) | (mass %) | (25° C.) |
| Comparative | 0 | 100 | — | 100 |
| Example 1 | | | | |
| Example 4 | 10 | 90 | 20 | 109 |
| Example 5 | 20 | 80 | 20 | 111 |
| Example 6 | 30 | 70 | 20 | 110 |
| Example 7 | 40 | 60 | 20 | 111 |
| Example 8 | 50 | 50 | 20 | 112 |
| Example 3 | 60 | 40 | 20 | 110 |
| Example 9 | 70 | 30 | 20 | 107 |
| Example 10 | 80 | 20 | 20 | 106 |
| Example 11 | 90 | 10 | 20 | 106 |
| Comparative | 100 | 0 | 20 | 102 |
| Example 6 | | | | |

As shown in Tables 1 and 2, in Examples 1 to 3 in which the polyvinylpyrrolidone-based polymer is added in an amount of 5 to 25 parts by mass relative to 100 parts by mass of the carbon nanotubes in accordance with the present invention, high output characteristics are exhibited compared with Comparative Example 1 in which acetylene black only is used as a conducting agent and the polyvinylpyrrolidone-based polymer is not used.

As is clear from Comparative Examples 3 to 5, when the addition amount of the polyvinylpyrrolidone-based polymer is excessively large, output characteristics are decreased. It is believed that, in Comparative Examples 3 to 5, since the content of the polyvinylpyrrolidone-based polymer is excessively high, the internal resistance of the electrode is increased, resulting in a decrease in output characteristics.

Furthermore, as is clear from comparison between Comparative Examples 1 and 2, in the case where a polyvinylpyrrolidone-based polymer is not added, when carbon nanotubes and a non-fibrous conductive carbon material are used together, the properties of the positive electrode mixture slurry are degraded to such an extent that an electrode cannot be fabricated.

As shown in Table 3, in Examples 3 to 11 in which the polyvinylpyrrolidone-based polymer is added in an amount of 20 parts by mass relative to 100 parts by mass of the carbon nanotubes and the carbon nanotubes and the non-fibrous conductive carbon material are used together at a mass ratio (carbon nanotubes:non-fibrous conductive carbon material) of 1:9 to 9:1 in accordance with the present invention, higher output characteristics are exhibited than those of Comparative Examples 1 and 6 in which carbon nanotubes and a non-fibrous conductive carbon material are not used together. It is evident that the mass ratio of the carbon nanotubes to the non-fibrous conductive carbon material is particularly preferably 1:9 to 3:2, and even when the carbon nanotube content is low, a good conductive network can be formed.

### REFERENCE SIGNS LIST

10 three-electrode test cell

11 working electrode (positive electrode)

12 counter electrode (negative electrode)

13 reference electrode

14 non-aqueous electrolytic solution

1-7. (canceled)

8. An electrode for a non-aqueous electrolyte secondary battery comprising an active material, a binder, carbon nanotubes, and a non-fibrous conductive carbon material, characterized in that the electrode includes a polyvinylpyrrolidone-based polymer in an amount in the range of 5 to 25 parts by mass relative to 100 parts by mass of the carbon nanotubes.

9. The electrode for a non-aqueous electrolyte secondary battery according to claim 8, characterized in that the diameter of the carbon nanotubes is 50 nm or less.

10. The electrode for a non-aqueous electrolyte secondary battery according to claim 8, characterized in that the mass ratio of the carbon nanotubes to the non-fibrous conductive carbon material is in the range of 1:9 to 9:1.

11. The electrode for a non-aqueous electrolyte secondary battery according to claim 9, characterized in that the mass ratio of the carbon nanotubes to the non-fibrous conductive carbon material is in the range of 1:9 to 9:1.

12. The electrode for a non-aqueous electrolyte secondary battery according to claim 8, characterized in that the active material is a lithium transition metal composite oxide containing nickel or manganese as a transition metal.

13. The electrode for a non-aqueous electrolyte secondary battery according to claim 9, characterized in that the active material is a lithium transition metal composite oxide containing nickel or manganese as a transition metal.

14. The electrode for a non-aqueous electrolyte secondary battery according to claim 10, characterized in that the active material is a lithium transition metal composite oxide containing nickel or manganese as a transition metal.

15. The electrode for a non-aqueous electrolyte secondary battery according to claim 11, characterized in that the active material is a lithium transition metal composite oxide containing nickel or manganese as a transition metal.

16. The electrode for a non-aqueous electrolyte secondary battery according to claim 8, characterized in that the non-fibrous conductive carbon material is carbon black.

17. The electrode for a non-aqueous electrolyte secondary battery according to claim 9, characterized in that the non-fibrous conductive carbon material is carbon black.

18. The electrode for a non-aqueous electrolyte secondary battery according to claim 10, characterized in that the non-fibrous conductive carbon material is carbon black.

19. The electrode for a non-aqueous electrolyte secondary battery according to claim 11, characterized in that the non-fibrous conductive carbon material is carbon black.

20. The electrode for a non-aqueous electrolyte secondary battery according to claim 12, characterized in that the non-fibrous conductive carbon material is carbon black.

21. The electrode for a non-aqueous electrolyte secondary battery according to claim 13, characterized in that the non-fibrous conductive carbon material is carbon black.

22. The electrode for a non-aqueous electrolyte secondary battery according to claim 14, characterized in that the non-fibrous conductive carbon material is carbon black.

23. The electrode for a non-aqueous electrolyte secondary battery according to claim 15, characterized in that the non-fibrous conductive carbon material is carbon black.

24. A non-aqueous electrolyte secondary battery characterized in that the electrode according to claim 8 is used as a positive electrode or a negative electrode.

25. A non-aqueous electrolyte secondary battery characterized in that the electrode according to claim 9 is used as a positive electrode or a negative electrode.

26. A non-aqueous electrolyte secondary battery characterized in that the electrode according to claim 10 is used as a positive electrode or a negative electrode.

27. A non-aqueous electrolyte secondary battery characterized in that the electrode according to claim 11 is used as a positive electrode or a negative electrode.
